(19) United States
(12) Patent Application Publication
(10) Pub. No.: US 2011/0088462 A1
(43) Pub. Date: Apr. 21, 2011

(54) DOWNHOLE MONITORING WITH DISTRIBUTED ACOUSTIC/VIBRATION, STRAIN AND/OR DENSITY SENSING

(75) Inventors: Etienne M. SAMSON, Houston, TX (US); Lawrence G. GRIFFIN, Houston, TX (US)

(73) Assignee: HALLIBURTON ENERGY SERVICES, INC., Houston, TX (US)

(21) Appl. No.: 12/603,334

(22) Filed: Oct. 21, 2009

(51) Int. Cl. E21B 47/10; G01N 21/47

(52) U.S. Cl. 73/152.18; 356/342

(57) ABSTRACT

Distributed acoustic, vibration, density and/or strain sensing is utilized for downhole monitoring. A method of tracking fluid movement along a wellbore of a well includes: detecting vibration, density, strain (static and/or dynamic) and/or Brillouin frequency shift in the well using at least one optical waveguide installed in the well; and determining the fluid movement based on the detected vibration, density, strain and/or Brillouin frequency shift. Another method of tracking fluid movement along a wellbore of a well includes: detecting a change in density of an optical waveguide in the well; and determining the fluid movement based on the detected density change.

### BACKGROUND

The present disclosure relates generally to equipment utilized and operations performed in conjunction with a subterranean well and, in an embodiment described herein, more particularly provides for downhole monitoring with distributed acoustic, vibration, strain and/or density sensing.

It is known to monitor distributed temperature along a wellbore, in order to detect movement of fluid along the wellbore. However, prior methods (such as DTS) have been based on detecting Raman backscattering in an optical fiber installed in the wellbore. Such methods generally require relatively slow effective sample rates, thereby providing relatively low temporal (and, thus, spatial) resolution.

Improvements are needed in well monitoring technology, for example, to monitor fluid movement in real time for injection and production operations.

### SUMMARY

In carrying out the principles of the present disclosure, systems and methods are provided which bring improvements to the art of downhole monitoring. One example is described below in which distributed acoustic/vibration sensing, distributed strain sensing and/or distributed density sensing is used to track fluid movement.

In one aspect, a method of tracking fluid movement along a wellbore of a well is provided. The method includes the steps of: detecting vibration in the well using at least one optical waveguide installed in the well; and determining the fluid movement based on the detected vibration.

In another aspect, a method of tracking fluid movement along a wellbore of a well includes the steps of: detecting strain in the well using at least one optical waveguide installed in the well; and determining the fluid movement based on the detected strain.

In yet another aspect, a method of tracking fluid movement along a wellbore of a well includes detecting a change in density of an optical waveguide in the well; and determining the fluid movement based on the detected density change.

In a further aspect, a method of tracking fluid 22 movement along a wellbore 12 includes detecting a Brillouin frequency shift (BFS) for light transmitted through an optical waveguide 26 in a well, and determining the fluid 22 movement along the wellbore 12 based on the detected Brillouin frequency shift (BFS).

These and other features, advantages and benefits will become apparent to one of ordinary skill in the art upon careful consideration of the detailed description of representative embodiments of the disclosure hereinbelow and the accompanying drawings, in which similar elements are indicated in the various figures using the same reference numbers.

### BRIEF DESCRIPTION OF THE DRAWINGS

FIG. 1 is a schematic view of a well system and method embodying principles of the present disclosure.

FIG. 2 is a schematic view of the well system and method, wherein a property change is introduced in fluid flowing through a wellbore.

FIG. 3 is a graph of vibration versus depth along the wellbore, showing vibration profiles at spaced time intervals.

FIGS. 4 & 5 are schematic cross-sectional views of optical waveguide cables which may be used in the system and method of FIG. 1.

FIGS. 6-8 are schematic elevational views of sensors which may be used in the system and method of FIG. 1.

FIG. 9 is a graph of optical intensity versus wavelength for various forms of optical backscattering.

FIG. 10 is a schematic view of optical equipment which may be used in the system and method of FIG. 1.

### DETAILED DESCRIPTION

Fluid movement in a well can be detected by observing the effect(s) of changes in the well due to the fluid movement. For example, a fluid having a different temperature from the well environment can be pumped into the well, and the effects of the temperature change in the well can be detected as an indication of the presence of the fluid. With an optical waveguide installed in the well, the temperature change can be detected at any position along the waveguide. Various techniques can be used to detect not only temperature change, but also, or alternatively, changes in strain, density, etc. as indications of the presence and position of the fluid at any point in time.

As another example, fluid flow can produce vibrations (e.g., pressure or strain fluctuations) due to turbulence in the flow, particles (such as sand, etc.) carried along with the fluid, etc. By detecting the vibrations produced by anomalies, signatures or “tracers” in the fluid flow, the presence and position of the fluid flow can be determined.

For underground oil & gas, geothermal, waste disposal, and carbon capture and storage (CCS) operations, monitoring fluid movement within and along the wellbore is useful. Specifically for wellbore stimulation activities (chemical injection, acidizing and hydraulic fracture treatments), it is useful to know the fluid movement (displacement) within and along the wellbore to determine the volume distribution of the injected fluid across the target interval and to identify possible undesired injection out of the target zone. For injection operations the velocity of the fluid proportionally decreases as fluid exits at various points along the wellbore.

This disclosure describes a technique which allows measuring the velocity of the fluid in and along the wellbore in real-time. This technique utilizes the differences in the fluid properties (if different fluids are injected) or induced fluid property changes by adding chemicals, materials, heating/cooling or mechanical devices to form the “tracers” to provide static or dynamic acoustic/vibrational, strain or density signatures.

One advantage of this technique over other methods is that the disturbances can now be detected over much shorter periods of time (less than a few seconds versus tens of seconds) allowing for accurate monitoring at much higher injection rates (velocities) and allowing for more detailed resolution of the flow distribution.

A preferred method for measuring dynamic acoustic/vibration disturbances (˜1 Hz to ≧10 KHz) is coherent Rayleigh backscatter detection. A preferred method for measuring static strain/density disturbances is stimulated Brillouin backscatter detection. The resulting Brillouin backscatter measurements can be (but are not necessarily) recalibrated “on the fly” to isolate strain effects from temperature effects, if desired.

This information can be used in evaluating the effectiveness of the injection operation through understanding the fluid distribution. Using this information in real time during injection, a pumping procedure can be modified or corrected in order to maximize its effectiveness. The information may also be used in planning future injection operations in the same or different wellbores.

The principles of this disclosure can also be applied to producing wells by introducing acoustic/vibrational, strain and/or density “tracers” downhole and monitoring their movement as they are produced up the wellbore, identifying velocity increases at fluid contribution points along the wellbore. The velocity will increase as fluid enters the wellbore.

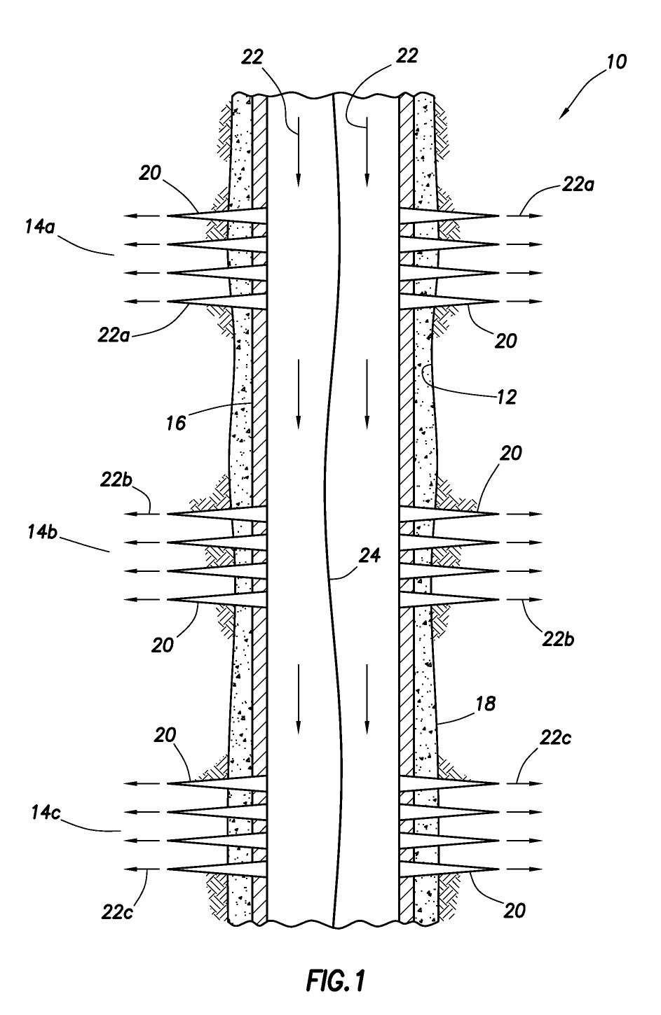

Representatively illustrated in FIG. 1 is a well system 10 and associated method which embody principles of the present disclosure. As depicted in FIG. 1, a wellbore 12 has been drilled, such that it intersects several subterranean formation zones 14a-c. The wellbore 12 has been lined with casing 16 and cement 18, and perforations 20 provide for fluid flow between the interior of the casing and the zones 14a-c.

At this point it should be noted that the system 10 as illustrated in FIG. 1 is merely one example of a wide variety of well systems which can utilize the principles described in this disclosure, and so it will be appreciated that those principles are not limited at all by the details of the example of the system 10 and associated method depicted in FIG. 1 and described herein. For example, although only three zones 14a-c are depicted in FIG. 1, any number of zones (including just one) may be intersected by, and in fluid communication with, the wellbore 12. As another example, it is not necessary for the wellbore 12 to be cased, since the wellbore could instead be uncased or open hole, at least in the portion of the wellbore intersecting the zones 14a-c. The zonal isolation provided by cement 18 could in other examples be provided using different forms of packers, etc.

As yet another example, fluid 22 is depicted in FIG. 1 as being injected into the well via the wellbore 12, with one portion 22a entering the zone 14a, another portion 22b entering the zone 14b, and another portion 22c entering the zone 14c. This may be the case in stimulation, conformance, storage, disposal and/or other operations in which fluid is injected into a wellbore.

However, in other operations (such as production, etc.) the direction of flow of the fluid 22 could be the reverse of that depicted in FIG. 1. Thus, the fluid portions 22a-c could instead be received from the respective zones 14a-c into the wellbore 12.

In other situations, fluid could be injected into one section of a well, and fluid could be received from the same or another section of the well, either simultaneously or alternately. Thus, it will be appreciated that a large variety of operations are possible in which the movement of fluid in a well could be monitored.

In order to provide for monitoring movement of the fluid 22, the system 10 and associated method utilize an optical waveguide cable 24 installed in the well. The cable 24 includes one or more optical waveguides (such as optical fiber(s), optical ribbon(s), other types of optical waveguides, as well as any other desired communication or power lines, etc.). As described more fully below, the optical waveguide(s) are useful in detecting density, dynamic strain, static strain, vibration, acoustic effects and/or other parameters distributed along the wellbore 12, as indications of movement of the fluid 22 along the wellbore.

A method described herein utilizes distributed acoustic/vibration, strain and/or density sensing instruments. A preferred embodiment for acoustic/vibration sensing employs one or more optical fibers to detect shear/compressional vibrations along the fiber disposed linearly along the wellbore 12. This embodiment essentially comprises an extended continuous fiber optic microphone, hydrophone or accelerometer, whereby the vibrational energy is transformed into a dynamic strain along the optical fiber.

Such strains within the optical fiber act to generate a proportional optical path length change measurable by various techniques. These techniques include, but are not limited to, interferometric (e.g., coherent phase Rayleigh), polarimetric, fiber Bragg grating wavelength shift, or photon-phonon-photon (Brillouin) frequency shift measurements for lightwaves propagating along the length of the optical fiber.

Optical path length changes result in a similarly proportional optical phase change or Brillioun frequency/phase shift of the lightwave at a particular distance-time, thus allowing remote surface detection and monitoring of acoustic/vibration amplitude and location continuously along the optical fiber.

Coherent phase Rayleigh sensing is preferably utilized to perform Distributed Vibration Sensing (DVS) or Distributed Acoustic Sensing (DAS). Stimulated Brillouin sensing is preferably utilized to perform Distributed Strain Sensing (DSS) for sensing relatively static strain changes along an optical fiber disposed linearly along the wellbore 12, but other techniques (such as coherent phase Rayleigh sensing) may be used if desired.

The DSS system preferably detects small strain changes that result from fluid property differences (primarily fluid friction differences, but could comprise other differences, such as temperature, etc.). As a strain “tracer” (a fluid having a different property from surrounding fluid) flows along the optical fiber, localized changes in strain in a pipe, tube or the fiber itself are detected.

By detecting the presence and position of the tracer at different points in time, the velocity and flow rate of the fluid can be readily determined. Changes in velocity and flow rate downhole can be used to determine how much of the fluid has been injected into, or produced from, perforated intervals where the changes occur.

Although the cable 24 is depicted in FIG. 1 as being installed by itself within the casing 16, this is but one example of a wide variety of possible ways in which the cable may be installed in the well. The cable 24 could instead be positioned in a sidewall of the casing 16, inside of a tubing which is positioned inside or outside of the casing or a tubular string within the casing, in the cement 18, or otherwise positioned in the well.

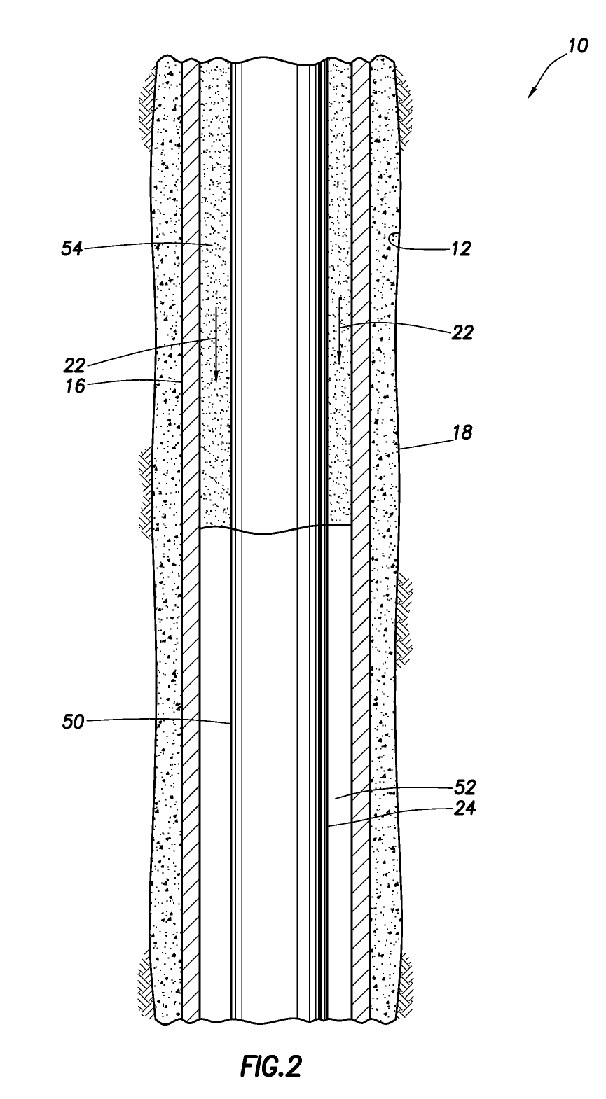

Referring additionally now to FIG. 2, another example of the system 10 is representatively illustrated, in which the cable 24 is attached externally to a tubular string 50 in the well. As discussed above, this is just one example of a variety of different ways in which the cable 24 could be installed in a well.

FIG. 2 also depicts the fluid 22 being flowed along the wellbore 12, with the fluid having a property change as compared to fluid 52 already present in the wellbore. A “signature” or “tracer” is represented by this property change, and can be detected using the principles described in this disclosure.

The property change could be implemented in a variety of ways, including but not limited to a change in temperature (i.e., the fluid 22 being hotter or colder than the fluid 52), fluid type, fluid friction, fluid chemistry, thermal property, particulate matter in the fluid, etc. The property change produces a corresponding change in vibration, dynamic strain, static strain, density and/or acoustic effects in the cable 24, which can be detected using the principles described in this disclosure.

For example, if the fluid 22 has particulate matter 54 (such as sand, fines, proppant, etc.) therein, greater vibration of the cable 24 will be produced as the fluid 22 flows along the wellbore 12, as compared to when the fluid 52 surrounds the cable. As another example, if the fluid 22 has a higher temperature as compared to the fluid 52, then as the fluid 22 comes into contact with the tubular string 50 and cable 24, these components will elongate, thereby changing an optical path length through the cable, changing strain in the cable, changing a density of an optical waveguide in the cable, etc. As yet another example, if the fluid 22 produces different frictional effects as compared to the fluid 52, then as the fluid 22 comes into contact with the tubular string 50 and cable 24, these components will respond differently to the changed frictional effects, thereby changing an optical path length through the cable, changing strain in the cable, changing a density of an optical waveguide in the cable, etc.

By detecting these changes in vibration, dynamic strain, static strain, density and/or acoustic effects utilizing the cable 24, the presence and location of the fluid 22 can be determined at various points in time. Using the principles of this disclosure, the delay between those points in time can be much shorter, thereby providing for much higher resolution and accuracy in tracking the fluid 22 as it flows along the wellbore 12.

Referring additionally now to FIG. 3, an example of how the detection of distributed density, dynamic strain, static strain, vibration and/or acoustic energy in real time along the cable 24 (or an optical waveguide 26 of the cable) may be used to track displacement of the fluid 22 in the well is representatively illustrated. As discussed above, DTS systems have been used in the past to track fluid displacement, but due to their large sample rate requirements, temporal/spatial resolution has been less than desired. Such a system is described in U.S. Publication No. 2007/0234788, assigned to the assignee of the present application.

The method disclosed herein can include use of distributed acoustic/vibration sensing (DAS, DVS) to monitor acoustic and vibration (dynamic strain) events, and/or distributed strain sensing (DSS) to monitor strain (static or absolute strain) events along the wellbore.

Sensing acoustic/vibration or strain instead of temperature (i.e., in contrast to the method as described in US 2007/0234788) enables accurate detection of a tracer (such as, a temperature or friction effects change/anomaly or vibration-producing substance, etc.) within very few seconds (e.g., using DSS) down to a fraction of a millisecond (e.g., using DAS or DVS), and with one meter or less spatial resolution, as compared to a minimum of tens of seconds and a spatial resolution that depends on fluid velocity when using DTS. Thus, the use of DAS and DSS as described herein will have significantly (e.g., orders of magnitude) better spatial and temporal resolution than DTS for tracking fluid movement in wells.

Advantages of this method include: (1) faster sample rates allow more detection points, giving finer spatial resolution for determining the fluid 22 distribution along the wellbore 12, (2) faster sample rates allow the method to be used with high rate injection operations, such as high rate hydraulic fracturing, etc., (3) since the data is not averaged over a period of time (e.g., using DAS, DVS), the tracer is not “blurred” (averaging over 2-3 seconds reduces the “blur” for DSS), allowing an analyst to more precisely locate the tracer, (4) the optical waveguide 26 will respond much quicker to strain (dynamic or static) events than to temperature, allowing even higher spatial resolution, and (5) the strain events do not necessarily dissipate as much as temperature variations do, as they move along the wellbore.

The method utilizes distributed acoustic/vibration or strain sensing instruments, such as the detectors 36, 38, 40, 42 described below. A preferred embodiment for detecting acoustic energy or vibration employs one or more optical waveguides 26 to detect shear/compressional vibrations along the waveguide, which is disposed linearly along the wellbore 12.

The waveguide 26 essentially becomes an extended continuous optical microphone, hydrophone or accelerometer, whereby the vibrational energy is transformed into a dynamic strain along the waveguide. Such strains within the waveguide 26 generate a proportional optical path length change, which is measurable by various techniques, such as interferometric (Rayleigh), polarimetric, Bragg grating wavelength shift, or photon-phonon-photon (Brillouin) frequency shift for any light waves propagating along the waveguide.

Such optical path length changes result in a similarly proportional optical phase change or Brillouin frequency/phase shift of the light wave at that distance-time, thus allowing remote detection and monitoring of acoustic amplitude and location continuously along the optical waveguide 26. Coherent phase Rayleigh backscattering detection may be used to perform Distributed Vibration Sensing (DVS) or Distributed Acoustic Sensing (DAS).

One preferred embodiment for static/absolute strain sensing employs one or more optical waveguides 26 to detect strain changes along the waveguide disposed linearly along the wellbore 12. The Distributed Strain Sensing (DSS) system detects small strain changes that result from fluid 22 property differences (primarily friction).

As the “strain” tracers 46 (e.g., due to different fluids, particles in the fluid, etc.) pass along the cable 24, momentary changes in the local strain of the tubular string 50 and/or associated waveguide 26 are detected and allow determining the fluid velocity (detected change in strain, vibration and/or density at Δdistance/Δtime). The method may specifically utilize Brillouin backscattering detection techniques for detecting the strain changes, however, Rayleigh backscattering detection or other techniques could also, or alternatively, be used to monitor the strain changes.

The method can be used to track movement of fluids with: (1) different properties, (2) specifically altered properties using physical or chemical additives, and/or (3) the addition of electronic or mechanical devices or substances used to create acoustic/vibration and/or static strain signatures. These signatures can be sensed using the waveguide 26 at any given location as the fluid 22 moves along the wellbore 12, thereby allowing the velocity of the fluid to be determined as it passes between any two points.

Using DAS, DVS and/or DSS techniques, the background “noise” in the well can be monitored in real time. As the fluid 22 or different fluids are injected or otherwise flowed through the wellbore 12, a change in the “noise” signature at any given depth and time can be detected.

If fluid 22 is pumped into the wellbore 12, and sand is introduced into the fluid at a known location X₀ at a known time T₀, then the conditions at T₀ may be used as a baseline (a known event at a known position and time). The strain tracer 46 depicted in FIG. 3 may be produced by introduced sand, or by other means.

At time T₁, the tracer 46 is detected at a given depth X₁, allowing the velocity of the fluid 22 between X₀ and X₁ to be readily determined. If the cross-sectional flow area of the conduit (such as the casing 16) through which the fluid 22 flows is known, then the volume of the fluid flowed through the conduit between T₀ and T₁ can also be readily determined.

At T₂, the tracer 46 has moved to location X₂. The DAS/DVS system preferably has a spatial resolution of ˜1 m so the distance from X₁ to X₂ can be calculated with acceptable accuracy. The sample rate may be as high as 10 KHz or one sample per 0.1 millisecond (or even faster), which will permit calculation of T₂-T₁ with high accuracy.

Thus, using these two parameters (X₂-X₁ and T₂-T₁) enables calculation of flow velocity and volume between specific intervals. As the tracer 46 moves across a perforated interval 48 (such as any of perforated zones 14a-c or zones otherwise in communication with the fluid flow), some amount of the fluid 22 will be lost to each zone and the remaining fluid will have a decreased velocity (assuming the flow area of the conduit through which the fluid flows remains constant).

This is visible in the graph of FIG. 3 as a reduced distance between X₂ and X₁ as compared to X₁ and X₀, a reduced distance between X₃ and X₂ as compared to X₂ and X₁, a reduced distance between X₄ and X₃ as compared to X₃ and X₂, etc. By calculating very accurately the fluid velocity distribution as the tracer 46 moves along the wellbore 12, an accurate determination of the volume of the fluid 22 flowed into each of the zones can be made. This enables determination of the fluid distribution (extent of fluid injected into each zone) with enhanced accuracy.

Of course, the method can also be used in cases of fluid production, for example, to determine the volume and flow rate of fluid produced from each zone 14a-c into the wellbore 12.

For use of DSS the concept is very similar except that the detected tracer 46 corresponds to strain and/or density changes associated with different fluid properties. Primarily, the strain or density change may be due to friction.

Fluids with different friction properties can impart an instantaneous strain or density change in the waveguide 26. For this dynamic measurement, the sample rate could also be as high as 10 KHz, or one sample per 0.1 millisecond (or even faster), which will allow calculation of time differences with high accuracy.

This method significantly improves spatial and sample resolution as compared to use of DTS. Such enhanced resolution allows for more accurate fluid velocity measurements over a wider range of fluid velocities for more precise determination of fluid distribution in a wellbore during injection and production operations.

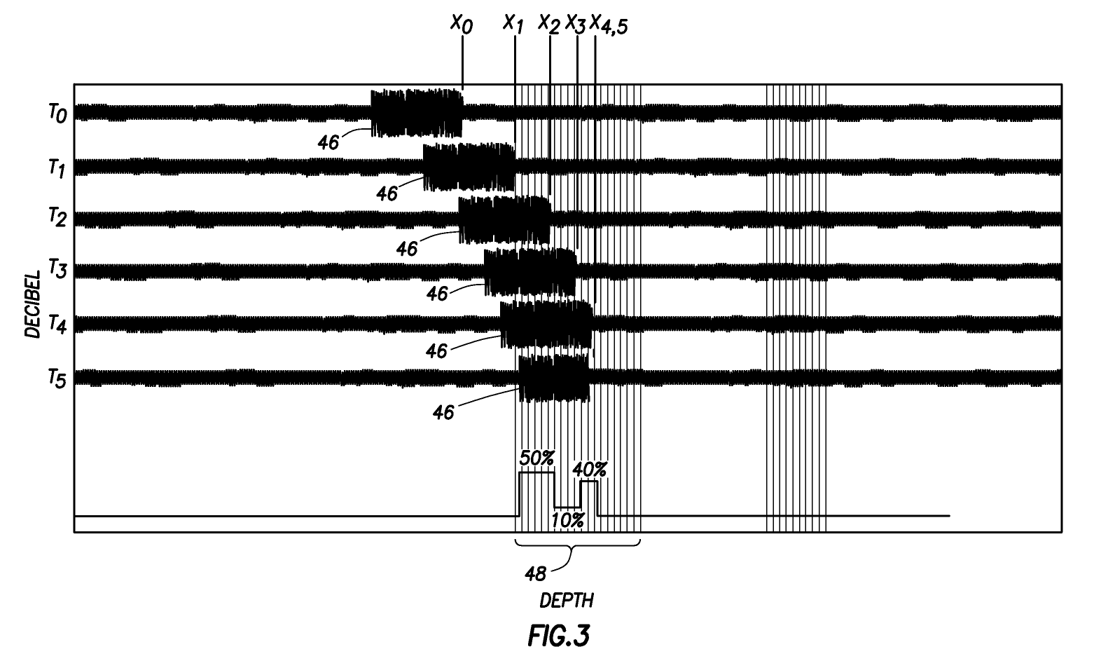

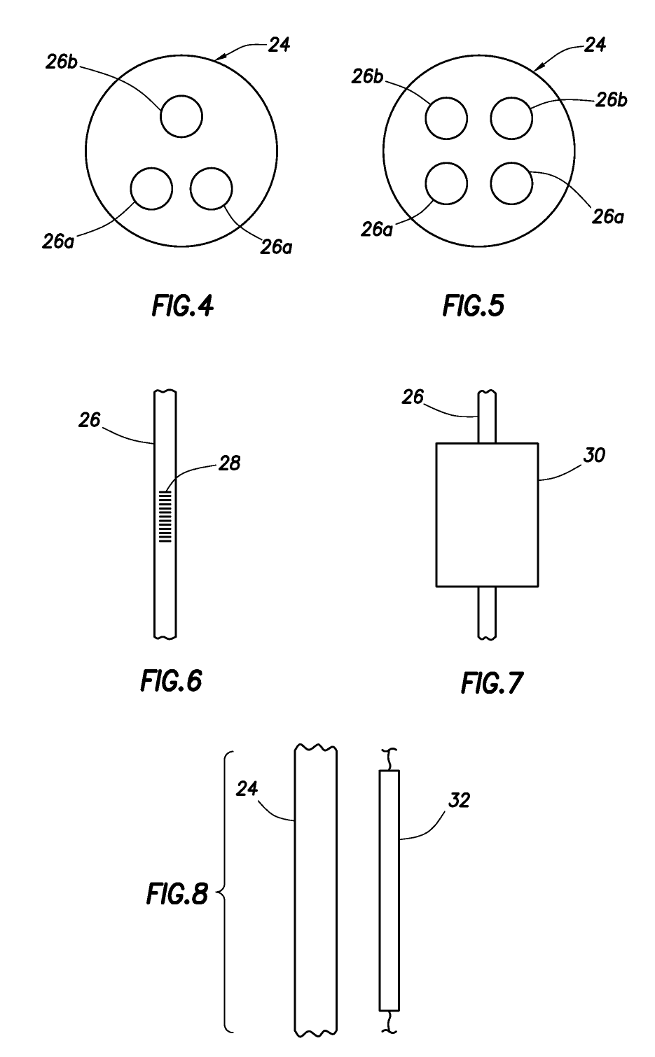

Referring additionally now to FIGS. 4 & 5, enlarged scale cross-sectional views of different configurations of the cable 24 are representatively illustrated. The cable 24 of FIG. 4 includes three optical waveguides 26, whereas the cable of FIG. 5 includes four optical waveguides. However, any number of optical waveguides 26 (including one) may be used in the cable 24, as desired.

The cable 24 could also include any other types of lines (such as electrical lines, hydraulic lines, etc.) for communication, power, etc., and other components (such as reinforcement, protective coverings, etc.), if desired. The cables 24 of FIGS. 4 & 5 are merely two examples of a wide variety of different cables which may be used in systems and methods embodying the principles of this disclosure.

Note that the cable 24 may preferably only utilize single mode waveguides for detecting Rayleigh and/or Brillouin backscatter. If Raman backscatter detection is utilized (e.g., for distributed temperature sensing), then multi-mode waveguide(s) may also be used for this purpose. However, it should be understood that multi-mode waveguides may be used for detecting Rayleigh and/or Brillouin backscatter, and/or single mode waveguides may be used for detecting Raman backscatter, if desired, but resolution may be detrimentally affected.

The cable 24 of FIG. 4 includes two single mode optical waveguides 26a and one multi-mode optical waveguide 26b. The single mode waveguides 26a are preferably optically connected to each other at the bottom of the cable 24, for example, using a conventional looped fiber or mini-bend. These elements are well known to those skilled in the art, and so are not described further herein.

In one example, a Brillouin backscattering detector is connected to the single mode optical waveguides 26a for detecting Brillouin backscattering due to light transmitted through the waveguides. A Raman backscattering detector is connected to the multi-mode optical waveguide 26b for detecting Raman backscattering due to light transmitted through the waveguide.

The cable 24 of FIG. 5 includes two single mode optical waveguides 26a and two multi-mode optical waveguides 26b. A Brillouin backscattering detector is preferably connected to the single mode optical waveguides 26a for detecting Brillouin backscattering due to light transmitted through the waveguides. A Raman backscattering detector may be connected to the multi-mode optical waveguides 26b, if desired, for detecting Raman backscattering due to light transmitted through the waveguides.

However, it should be understood that any optical detectors and any combination of optical detecting equipment may be connected to the optical waveguides 26a,b in keeping with the principles of this disclosure. For example, a coherent phase Rayleigh backscattering detector, an interferometer, or any other types of optical instruments may be used.

Referring additionally now to FIG. 6, any of the optical waveguides 26 (which may be single mode or multi-mode waveguide(s)) may be provided with one or more Bragg gratings 28. As is well known to those skilled in the art, a Bragg grating 28 can be used to detect strain and a change in optical path length along the waveguide 26.

A Bragg grating 28 can serve as a single point strain sensor, and multiple Bragg gratings may be spaced apart along the waveguide 26, in order to sense strain at various points along the waveguide. An interferometer may be connected to the waveguide 26 to detect wavelength shift in light reflected back from the Bragg grating 28.

Since a change in temperature will also cause a change in optical path length along the waveguide 26, the Bragg grating 28 can also, or alternatively, be used as a temperature sensor to sense temperature along the waveguide. If multiple Bragg gratings 28 are spaced out along the waveguide 26, then a temperature profile along the waveguide 26 can be detected using the Bragg gratings.

Referring additionally now to FIG. 7, an optical sensor 30 may be positioned on any of the optical waveguides 26. The sensor 30 may be used to measure temperature, strain or any other parameter or combination of parameters along the waveguide. Multiple sensors 30 may be distributed along the length of the waveguide 26, in order to measure the parameter(s) as distributed along the waveguide.

Any type of optical sensor 30 may be used for measuring any parameter in the system 10. For example, a Bragg grating 28, a polarimetric sensor, an interferometric sensor, and/or any other type of sensor may be used in keeping with the principles of this disclosure.

Referring additionally now to FIG. 8, another sensor 32, such as an electronic sensor, may be used in conjunction with the cable 24 to sense parameters in the well. The sensor 32 could, for example, comprise an electronic sensor for sensing one or more of temperature, strain, vibration, acoustic energy, or any other parameter. Multiple sensors 32 may be distributed in the well, for example, to measure the parameter(s) as distributed along the wellbore 12.

Note that use of the Bragg grating 28 and/or other sensors 30, 32 is not necessary in keeping with the principles of this disclosure.

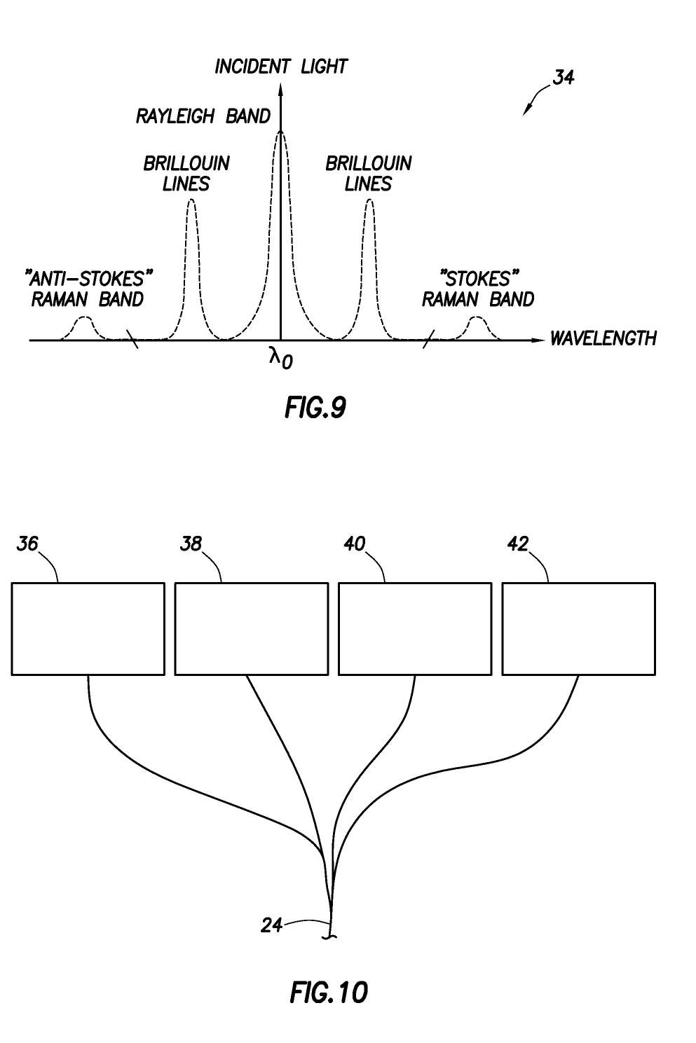

Referring additionally now to FIG. 9, a graph 34 of various forms of optical backscattering due to light being transmitted through an optical waveguide is representatively illustrated. The graph 34 shows relative optical intensity of the various forms of backscattering versus wavelength. At the center of the abscissa is the wavelength λ₀ of the light initially launched into the waveguide.

Rayleigh backscattering has the highest intensity and is centered at the wavelength λ₀. Rayleigh backscattering is due to microscopic inhomogeneities of refractive index in the waveguide material matrix.

Note that Raman backscattering (which is due to thermal excited molecular vibration known as optical phonons) has an intensity which varies with temperature T, whereas Brillouin backscattering (which is due to thermal excited acoustic waves known as acoustic phonons) has a wavelength which varies with both temperature T and strain E. Detection of Raman backscattering is typically used in distributed temperature sensing (DTS) systems, due in large part to its direct relationship between temperature T and intensity, and almost negligent sensitivity to strain E.

However, the Raman backscattering intensity is generally less than that of Rayleigh or Brillouin backscattering, giving it a correspondingly lower signal-to-noise ratio. Consequently, it is common practice to sample the Raman backscattering many times and digitally average the readings, which results in an effective sample rate of from tens of seconds to several minutes, depending on the signal-to-noise ratio, fiber length and desired accuracy. This is too slow of an effective sample rate to track fast moving fluid in a wellbore.

In contrast to conventional practice, the system 10 and associated method use detection of changes in vibration, strain and/or density along the waveguide 26 to increase the effective sample rate from a matter of a few seconds down to less than a second, which is very useful in tracking fluid displacement along a wellbore, since fluid can be flowed a large distance in a short period of time.

For intense beams (e.g. laser light) traveling in a medium such as an optical fiber, the variations in the electric field of the beam itself may produce acoustic vibrations in the medium via electrostriction. The beam may undergo Brillouin scattering from these vibrations, usually in an opposite direction to the incoming beam, a phenomenon known as stimulated Brillouin scattering (SBS). For liquids and gases, typical frequency shifts are of the order of 1-10 GHz (wavelength shifts of ˜1-10 pm for visible light). Stimulated Brillouin scattering is one effect by which optical phase conjugation can take place.

Brillouin backscattering detection measures a frequency shift (Brillouin frequency shift, BFS), with the frequency shift being sensitive to localized density ρ of the waveguide 26. Density ρ is affected by two parameters: strain ε and temperature T. Thus:

BFS(ρ)=BFS(ε)+BFS(T) (1)

In order to isolate the BFS due to either strain or temperature change, the other parameter can be separately measured. Preferably, the other parameter is measured at multiple points along the waveguide 26 at regular time intervals, and these measurements are used to refine or recalibrate the determinations of BFS for the parameter of interest.

The properties of the waveguide 26 being known, the BFS(T) can be subtracted from the detected BFS(ρ) to yield BFS(ε), thereby enabling the distributed strain along the waveguide to be readily calculated. Note that it is not necessary to perform the intermediate calculations of BFS(ε) and BFS(T), since the response (density change) of the waveguide 26 material due to strain and temperature changes are known properties of the material.

If it is desired to detect strain distribution along the wellbore 12 using Brillouin backscattering detection, a separate measurement of temperature along the waveguide 26 (e.g., using any of the sensors discussed herein) may be performed, and those measurements can be used to separate out the effect of temperature change on the density change of the waveguide. Thus, distributed strain along the waveguide 26 can be readily determined using the principles of this disclosure.

However, it should be understood that it is not necessary to separate out either of the BFS(ε) and BFS(T) from the detected BFS(ρ). Instead, a monitoring system can simply track a disturbance or anomaly as it moves in the wellbore by observing the change in detected BFS due to density change in the optical waveguide 26. Density changes in the waveguide 26 can be caused by various occurrences (such as temperature change, fluid friction elongating or ballooning a tubular, etc.). By detecting the density change in the optical waveguide 26, the presence and location of the cause of the density change can be readily determined.

A preferred embodiment utilizes a cable 24 with at least two single mode and one multi-mode optical waveguide 26a,b as depicted in FIG. 4. The single mode waveguides 26a would be connected together at their bottom ends using a looped fiber or mini-bend. A stimulated Brillouin backscattering detector 36 (see FIG. 8), looking at Brillouin gain, would be connected to the single mode waveguides 26a of the cable 24 (for example, at the surface or another remote location), collecting readings at a relatively fast sample rate of ˜1-5 seconds.

A Raman backscattering detector 38 could be connected to the multi-mode waveguide 26b of the cable 24 and used to collect DTS temperature profiles at a much slower sample rate. Periodically, the Raman-based temperature profile could be used to recalibrate or refine the Brillouin-based strain profile along the wellbore 12, if desired. In another embodiment, the Raman backscattering detector 38 could be connected to multiple multi-mode waveguides 26b, as in the cable 24 depicted in FIG. 5.

In yet another embodiment, a coherent phase Rayleigh backscattering detector 40 may be connected to the cable 24, and/or an interferometer 42 may be connected to the cable, for accomplishing measurement of vibration along the waveguide 26. The detectors 36, 38, 40, 42 are not necessarily separate instruments. It should be understood that any technique for measuring the parameters in the well may be used, in keeping with the principles of this disclosure.

It may now be fully appreciated that the above disclosure provides many advancements to the art of monitoring fluid movement in a well. Fluid movement can be detected and monitored much more accurately, as compared to prior methods, using the principles described above.

The above disclosure describes a method of tracking fluid 22 movement along a wellbore 12 of a well. The method includes detecting vibration or strain in the well using at least one optical waveguide 26 installed in the well; and determining the fluid 22 movement based on the detected vibration or strain.

The detecting step may include detecting coherent phase Rayleigh backscattering due to light transmitted through the optical waveguide 26. The detecting step may also, or alternatively, be performed by detecting Brillouin backscattering due to light transmitted through the optical waveguide 26, by detecting an optical path length change in the optical waveguide, or by detecting a wavelength shift for light reflected off of a Bragg grating 28.

The method may include introducing a substance (such as sand or other particulate matter, another fluid, a fluid having a different frictional property, a fluid having a different thermal property, a fluid having a different density, etc.) into the fluid 22, whereby movement of the substance with the fluid 22 generates the vibration or strain.

The method may include introducing a property change into the fluid 22, whereby movement of the property change with the fluid 22 generates the strain. The property change may comprise a change of fluid type, a change of fluid friction, a change in fluid temperature, a change in fluid chemistry, and/or a change in a thermal property of the fluid 22.

The above disclosure also describes a method of tracking fluid movement along a wellbore 12 of a well, which method includes detecting a change in density of an optical waveguide 26 in the well, and determining the fluid movement based on the detected density change.

One method of tracking fluid 22 movement along a wellbore 12 described above includes detecting a Brillouin frequency shift (BFS) for light transmitted through an optical waveguide 26 in a well, and determining the fluid 22 movement along the wellbore 12 based on the detected Brillouin frequency shift (BFS).

The detecting step may include detecting Brillouin backscattering due to the light transmitted through the optical waveguide 26.

The method may include introducing a property change into the fluid 22, whereby movement of the property change with the fluid generates the Brillouin frequency shift (BFS). The property change may comprise a change of fluid type, fluid temperature, fluid chemistry, and/or a change in a thermal property of the fluid 22.

The Brillouin frequency shift (BFS) may be in response to a change in strain and/or a change in temperature in the optical waveguide 26.

It is to be understood that the various embodiments of the present disclosure described herein may be utilized in various orientations, such as inclined, inverted, horizontal, vertical, etc., and in various configurations, without departing from the principles of the present disclosure. The embodiments are described merely as examples of useful applications of the principles of the disclosure, which is not limited to any specific details of these embodiments.

In the above description of the representative embodiments of the disclosure, directional terms, such as “above”, “below”, “upper”, “lower”, etc., are used for convenience in referring to the accompanying drawings. In general, “above”, “upper”, “upward” and similar terms refer to a direction toward the earth's surface along a wellbore, and “below”, “lower”, “downward” and similar terms refer to a direction away from the earth's surface along the wellbore.

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of the present disclosure. Accordingly, the foregoing detailed description is to be clearly understood as being given by way of illustration and example only, the spirit and scope of the present invention being limited solely by the appended claims and their equivalents.

What is claimed is:

1. A method of tracking fluid movement along a wellbore of a well, the method comprising:
detecting vibration in the well using at least one optical waveguide installed in the well; and
determining the fluid movement based on the detected vibration.

2. The method of claim 1, wherein the detecting step further comprises detecting coherent phase Rayleigh backscattering due to light transmitted through the at least one optical waveguide.

3. The method of claim 1, wherein the detecting step further comprises detecting Brillouin backscattering due to light transmitted through the at least one optical waveguide.

4. The method of claim 1, wherein the detecting step further comprises detecting an optical path length change in the at least one optical waveguide.

5. The method of claim 1, wherein the detecting step further comprises detecting a wavelength shift for light reflected off of a Bragg grating.

6. The method of claim 1, further comprising the step of introducing a substance into the fluid, whereby movement of the substance with the fluid generates the vibration.

7. A method of tracking fluid movement along a wellbore of a well, the method comprising:
detecting strain in the well using at least one optical waveguide installed in the well; and
determining the fluid movement based on the detected strain.

8. The method of claim 7, wherein the detecting step further comprises detecting coherent phase Rayleigh backscattering due to light transmitted through the at least one optical waveguide.

9. The method of claim 7, wherein the detecting step further comprises detecting Brillouin backscattering due to light transmitted through the at least one optical waveguide.

10. The method of claim 7, wherein the detecting step further comprises detecting a change in an optical path length through the at least one optical waveguide.

11. The method of claim 7, wherein the detecting step further comprises detecting density change in the at least one optical waveguide, the density change producing a frequency shift in light transmitted through the at least one optical waveguide.

12. The method of claim 7, wherein the detecting step further comprises detecting a wavelength shift for light reflected off of a Bragg grating.

13. The method of claim 7, further comprising the step of introducing a property change into the fluid, whereby movement of the property change with the fluid generates the strain.

14. The method of claim 13, wherein the property change comprises a change of fluid type.

15. The method of claim 13, wherein the property change comprises a change in fluid friction.

16. The method of claim 13, wherein the property change comprises a change in fluid temperature.

17. The method of claim 13, wherein the property change comprises a change in fluid chemistry.

18. The method of claim 13, wherein the property change comprises a change in a thermal property of the fluid.

19. A method of tracking fluid movement along a wellbore of a well, the method comprising:
detecting a change in density of an optical waveguide in the well; and
determining the fluid movement based on the detected density change.

20. The method of claim 19, wherein the detecting step further comprises detecting coherent phase Rayleigh backscattering due to light transmitted through the optical waveguide.

21. The method of claim 19, wherein the detecting step further comprises detecting Brillouin backscattering due to light transmitted through the optical waveguide.

22. The method of claim 19, wherein the density change produces a frequency shift in light transmitted through the optical waveguide.

23. The method of claim 19, wherein the detecting step further comprises detecting a wavelength shift for light reflected off of a Bragg grating.

24. The method of claim 19, further comprising the step of introducing a property change into the fluid, whereby movement of the property change with the fluid generates the change in density.

25. The method of claim 24, wherein the property change comprises a change of fluid type.

26. The method of claim 24, wherein the property change comprises a change in fluid temperature.

27. The method of claim 24, wherein the property change comprises a change in fluid chemistry.

28. The method of claim 24, wherein the property change comprises a change in a thermal property of the fluid.

29. A method of tracking fluid movement along a wellbore of a well, the method comprising:
detecting a Brillouin frequency shift for light transmitted through an optical waveguide in the well; and
determining the fluid movement along the wellbore based on the detected Brillouin frequency shift.

30. The method of claim 29, wherein the detecting step further comprises detecting Brillouin backscattering due to the light transmitted through the optical waveguide.

31. The method of claim 29, further comprising the step of introducing a property change into the fluid, whereby movement of the property change with the fluid generates the Brillouin frequency shift.

32. The method of claim 31, wherein the property change comprises a change of fluid type.

33. The method of claim 31, wherein the property change comprises a change in fluid temperature.

34. The method of claim 31, wherein the property change comprises a change in fluid chemistry.

35. The method of claim 31, wherein the property change comprises a change in a thermal property of the fluid.

36. The method of claim 29, wherein the Brillouin frequency shift is in response to a change in strain in the optical waveguide.

37. The method of claim 29, wherein the Brillouin frequency shift is in response to a change in temperature of the optical waveguide.
